(19) United States
(12) Patent Application Publication
(10) Pub. No.: US 2024/0178911 A1
(43) Pub. Date: May 30, 2024

(54) LOW-ORBIT SATELLITE AND SATELLITE SYSTEM INCLUDING THE SAME, AND CONTROL METHOD THEREOF

(71) Applicant: KOREA AEROSPACE RESEARCH INSTITUTE, Daejeon (KR)

(72) Inventors: SUNGHYUCK IM, Daejeon (KR); KEEJOO LEE, Daejeon (KR); JAESUNG PARK, Daejeon (KR)

(21) Appl. No.: 18/521,838

(22) Filed: Nov. 28, 2023

(30) Foreign Application Priority Data
Nov. 28, 2022 (KR) 10-2022-0161388

(51) Int. Cl. H04B 7/185; G01S 19/11

(52) U.S. Cl. CPC H04B 7/18519; G01S 19/115; H04B 7/18513

(57) ABSTRACT

The present disclosure relates to a satellite system, and more particularly, to a satellite navigation system with high positioning accuracy. According to a low-orbit satellite, a satellite system including the same, and a control method thereof according to the present disclosure, a low-orbit satellite with high positioning accuracy is applied, but in order to reduce costs, the low-orbit satellite relays a signal from the existing high-orbit satellite and transmits the relayed signal to a signal receiving unit, thereby positioning of the receiving unit with high accuracy at low cost.

### CROSS-REFERENCE TO RELATED APPLICATION

This application claims priority under 35 U.S.C. § 119 to Korean Patent Application No. 10-2022-0161388, filed on Nov. 28, 2022, in the Korean Intellectual Property Office, the disclosure of which is incorporated herein by reference in its entirety.

### TECHNICAL FIELD

The following disclosure relates to a satellite system, and more particularly, to a satellite navigation system with high positioning accuracy.

### BACKGROUND

Satellite-based positioning systems may provide positioning services to a wider area than ground-based positioning systems. A low-orbit satellite may receive mid-orbit and high-orbit navigation satellite signals similar to the ground. Currently, examples of satellite navigation systems include GPS, GLONASS, GALILEO, BEIDOU, QZSS, KPS (project commencement), and the like, and the number of available (visible) satellites at the same time is approximately 30 to 40, and these satellites are evenly distributed on a celestial sphere.

A navigation payload mounted on artificial satellites used in the existing satellite navigation systems is equipped with a high-performance/expensive atomic clock that has high complexity and maintains a high-performance signal generation function and a time. In order to construct a navigation system with a small number of satellites equipped with the high-performance atomic clock, these satellites mainly move in medium and high orbits and generated signals to a receiving unit. However, since a high-orbit satellite has a low Doppler due to a small movement trajectory during the same time, when a distance is measured by receiving a signal for a certain period of time, the signal reception time is shorter than a cycle of multipath errors of the high-orbit satellite, so it is difficult to accurately measure the distance.

Accordingly, a method of applying a low-orbit satellite to a satellite navigation system was proposed, but the low-orbit satellite requires at least 400 satellites to construct a navigation system. As a result, when each satellite includes an expensive navigation payload, a problem occurs in which costs of constructing a system increase exponentially.

### RELATED ART DOCUMENT

[Patent Document]
(Patent Document 1) Korean Patent No. 10-0411758 “Interface between ground system in local area augmentation system and method for controlling data flow between ground systems” (Dec. 6, 2003)

### SUMMARY

An embodiment of the present disclosure is directed to providing a low-orbit satellite, a satellite system including the same, and a control method thereof, in which the low-orbit satellite with high positioning accuracy is applied, but in order to reduce costs, the low-orbit satellite relays a signal from the existing high-orbit satellite and transmits the relayed signal to a signal receiving unit, thereby performing positioning the receiving unit with high accuracy at low cost.

In one general aspect, a low-orbit satellite relaying signals from a plurality of high-orbit satellites to a ground receiving unit includes: an antenna unit configured to receive a signal of the high-orbit satellite; a transmitting unit configured to receive the signal from the antenna unit and transmit the signal to the receiving unit; and a control unit configured to control the antenna unit, in which the control unit may designate at least one of the high-orbit satellites as a designated satellite and control the antenna unit to receive signals from the designated satellite.

The antenna unit may include a plurality of fixed antennas spaced apart from each other by a predetermined angle.

The antenna unit may include at least one of a helical antenna or a parabolic antenna whose angle is changed by the control unit.

The antenna unit may include an array antenna where the control unit adjusts an array according to a predetermined gain value.

The control unit may control a signal reception direction of the antenna unit so that a reception range of the antenna unit overlaps a signal transmission range of the designated satellite.

The control unit may receive a signal and source information of the signal from the antenna unit, and determine that the source information of the signal is external interference information when the source information of the signal does not match source information of the designated satellite, and discard signal data.

In another general aspect, a satellite system which is a signal relay system of relaying a signal including a low-orbit satellite includes: a plurality of low-orbit satellites including the characteristics of claim 1; a receiving unit configured to receive a signal from the low-orbit satellite; a plurality of high-orbit satellites configured to transmit the signal to the antenna unit of the low-orbit satellite; and a server configured to receive signal information from the receiving unit and calculate and store positional information of the receiving unit.

The server may designate at least one of the high-orbit satellites positioned within a predetermined distance range in a traveling direction of each low-orbit satellite as the designated satellite of the low-orbit satellite based on orbit information and a signal reception range of the low-orbit satellite and orbit information and a signal transmission range of the high-orbit satellite.

The server derives a travel time of a signal and a pseudo-orange from the received signal, and stores a first delay time, which is a signal transmission time between the high-orbit satellite and the low-orbit satellite, and a second delay time, which is a signal transmission time between the low-orbit satellite and the receiving unit, and corrects the first delay time and the second delay time with the derived pseudo-range to determine a position of the receiving unit.

The server may designate a predetermined determination time and derive position result values of the receiving unit from each signal received within the determination time, and determine an average value of the position result values of the receiving unit as a final position of the receiving unit.

In still another general aspect, a control method of a satellite system including a low-orbit satellite to relay a signal includes: (a) generating, by a high-orbit satellite, a signal; (b) receiving, by the low-orbit satellite, the signal from the high-orbit satellite; (c) transmitting, by the low-orbit satellite, the signal to a receiving unit; and (d) determining, by the server, a position of the receiving unit.

The step (b) may include, by the server, (b1) searching for the high-orbit satellite adjacent to each low-orbit satellite and designating the searched high-orbit satellite as a designated satellite, (b2) communicating with a control unit of the low-orbit satellite to control a signal reception direction of an antenna unit, and (b3) receiving, by the antenna unit, the signal from the high-orbit satellite.

The step (b) may further include, by the control unit, (b4) following the step (b3) and discarding interference information when source information of the signal received from the antenna unit does not match source information of the designated satellite.

### BRIEF DESCRIPTION OF THE DRAWINGS

FIG. 1 is a block diagram illustrating a basic configuration of a low-orbit satellite of the present disclosure.

FIG. 2 is a schematic diagram illustrating an antenna unit of a low-orbit satellite according to a first embodiment of the present disclosure.

FIG. 3 is a schematic diagram illustrating an antenna unit of a low-orbit satellite according to a second embodiment of the present disclosure.

FIG. 4 is a schematic diagram illustrating an antenna unit of a low-orbit satellite according to a third embodiment of the present disclosure.

FIG. 5 is a block diagram illustrating a configuration of a transmitting unit of the low-orbit satellite of the present disclosure.

FIG. 6 is a schematic diagram illustrating a configuration of the satellite system of the present disclosure.

FIG. 7 is a block diagram illustrating a coupling relationship between a server, a high-orbit satellite, and a low-orbit satellite of the present disclosure.

FIG. 8 is a flowchart illustrating a control method of a satellite system of the present disclosure.

FIG. 9 is a flowchart illustrating detailed steps of a signal receiving step.

### DETAILED DESCRIPTION OF MAIN ELEMENTS

1000: Satellite system
100: Low-orbit satellite
110: Antenna unit
120: Transmitting unit
130: Control unit
200: Receiving unit
300: High-orbit satellite
400: Server

### DETAILED DESCRIPTION OF EMBODIMENTS

Hereinafter, the technical spirit of the present disclosure will be described in more detail with reference to the accompanying drawings. Terms and words used in the present specification and claims are not to be construed as a general or dictionary meaning, but are to be construed as meaning and concepts meeting the technical ideas of the present disclosure based on a principle that the present inventors may appropriately define the concepts of terms in order to describe their disclosures in best mode.

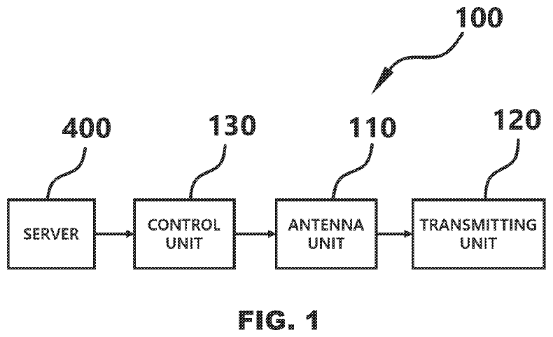

Hereinafter, a basic configuration of a satellite system 1000 of the present disclosure will be described with reference to FIG. 1.

As illustrated in FIG. 1, a low-orbit satellite 100 of the present disclosure is a low-orbit satellite 100 that relays signals from a plurality of high-orbit satellites 300 to a ground receiving unit 200, and may orbit at an altitude of 2000 km from the ground with an orbital period within 2 hours. The low-orbit satellite 100 of the present disclosure may include an antenna unit 110 that receives the signal from the high-orbit satellite 300, a transmitting unit 120 that receives a signal from the antenna unit 110 and transmits the signal to the receiving unit 200, and a control unit 130 that controls the antenna unit 110.

In this way, by allowing the low-orbit satellite 100 to relay the signal from the high-orbit satellite 300, the low-orbit satellite 100 with high positioning accuracy is applied. However, by relaying the signal from the existing high-orbit satellite 300, it is possible to increase the accuracy of signal transmission and reception even if the low-orbit satellite 100 does not include an expensive, high-performance payload, and to determine the position of the receiving unit 200 with higher accuracy.

In this case, the control unit 130 may designate at least one of the high-orbit satellites 300 as a designated satellite and control the antenna unit 110 to receive a signal from the designated satellite. In more detail, the low-orbit satellite 100 moves at a faster speed at a lower altitude than the high-orbit satellite 300, so the corresponding neighboring high-orbit satellite 300 may vary according to the movement of the low-orbit satellite 100. Accordingly, the server 400, which will be described later, may match the low-orbit satellite 100 and its neighboring high-orbit satellites 300, respectively, based on orbit and velocity information of the low-orbit satellite 100 and the high-orbit satellite 300.

Thereafter, the control unit 130 may control a signal reception direction of the antenna unit 110 so that a reception range of the antenna unit 110 overlaps a signal transmission range of the designated satellite. In more detail, as described above, after one of the high-orbit satellites 300 is designated as the designated satellite according to the position of the low-orbit satellite 100, the control unit 130 may control the signal reception direction of the antenna unit 110 to be toward the designated satellite based on a phase difference between the designated satellite and the low-orbit satellite 100 so that the signal from the designated satellite may be received more accurately. Thereafter, the low-orbit satellite 100 may receive a GNSS signal of the high-orbit signal, and convert the signal into a frequency that the above-described receiving unit 200 may receive and relay the signal.

In addition, the control unit 310 may receive a signal and source information of the signal from the antenna unit 110, and determine that the source information of the signal is external interference information when the source information of the signal does not match source information of the designated satellite, and discard signal data. Accordingly, when the low-orbit satellite 100 enters the signal transmission range of the plurality of high-orbit satellites 300, the low-orbit satellite 100 may transmit the signal from the high-orbit satellite 300 other than the designated satellite to prevent the information from interfering.

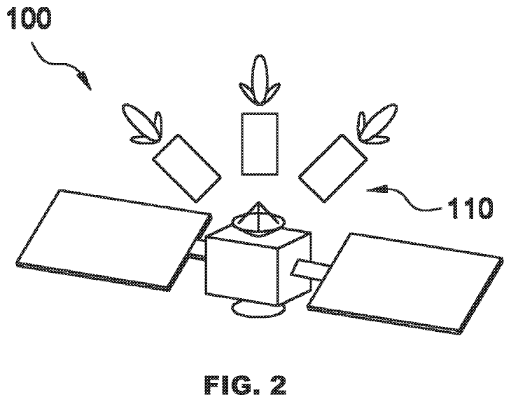

Hereinafter, the antenna unit 110 will be described in more detail with reference to FIGS. 2 to 4.

As illustrated in FIG. 2, the antenna unit 110 preferably includes a plurality of fixed antennas spaced apart from each other by a predetermined angle. The fixed antenna has a form in which an angle, a phase, and a signal reception range and direction are fixed. By installing fixed antennas at each angle, no matter which direction the designated satellite is positioned on the low-orbit satellite 100, the fixed antenna may easily receive the GNSS signal of the high-orbit satellite 300.

In this case, the installation angle of the fixed antenna may be optimized so that the low-orbit satellite 100 may detect the high-orbit satellite 300 in the widest possible range based on an altitude difference between the high-orbit satellite 300 and the low-orbit satellite 100, the number of high-orbit satellites 300, the number of low-orbit satellites 100, and velocity information of the high-orbit satellite 300 and the low-orbit satellite 100, respectively. For example, as the altitude difference between the high-orbit satellite 300 and the low-orbit satellite 100 increases, the fixed antenna may be designed so that the angle difference between the fixed antennas is minimized and the signal reception direction of the fixed antenna faces upward. In addition, when the number of low-orbit satellites 100 is small compared to the number of high-orbit satellites 300, the angle difference between the fixed antennas may be maximized.

In this case, the control unit 130 may receive positional information of the designated satellite from the server 400 and select the fixed antenna to receive the signal from the designated satellite, and may convert only the GNSS signal received from the selected fixed antenna and transmit the GNSS signal to the receiving unit 200 of the ground. It is preferable to discard the GNSS signal received from other antennas or the GNSS signal that is received from the selected fixed antenna but whose source information does not match the designated satellite. In this case, the signal reception details and the signal reception direction are stored and then transmitted to the server 400, so the server 400 may be used to double check the positional information of the high-orbit satellite 300.

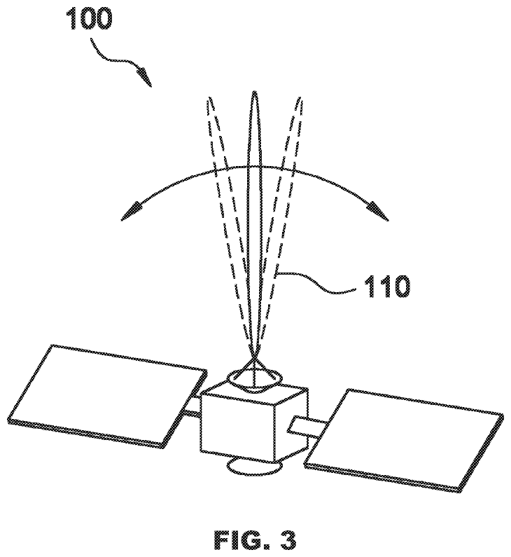

As illustrated in FIG. 3, the antenna unit 110 preferably includes at least one of a helical antenna or a parabolic antenna whose angle is changed by the control unit 130. In the case of the helical antenna or the parabolic antenna, the angle may be mechanically changed by the control unit 130, and the signal reception direction may be adjusted. In this case, the control unit 130 may receive the positional information of the designated satellite from the server 400 and derive a target phase of the antenna unit 110. Alternatively, the target phase of the antenna unit 110 may be received from the server 400. Thereafter, the signal reception direction may be adjusted by mechanically changing the angle of the antenna unit 110 including the helical antenna or the parabolic antenna.

Thereafter, the control unit 130 may convert the GNSS signal received from the antenna unit 110 and transmit the GNSS signal to the receiving unit 200 of the ground. When a signal is received from the high-orbit satellite 300 other than the designated satellite, it is preferable to discard the signal. In this case, the signal reception details and the signal reception direction are stored and then transmitted to the server 400, so the server 400 may be used to double check the positional information of the high-orbit satellite 300.

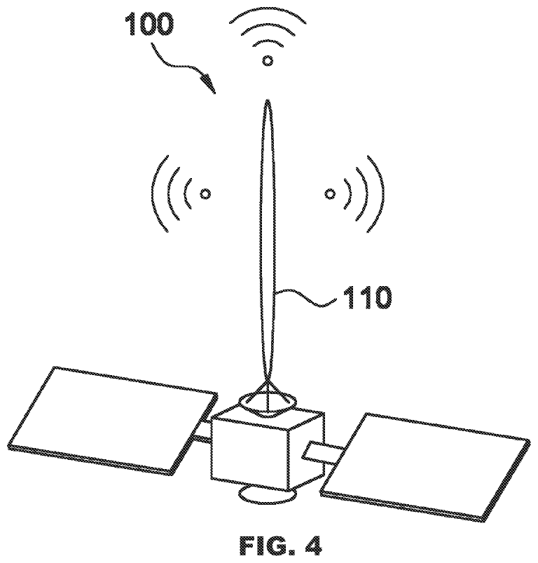

As illustrated in FIG. 4, the antenna unit 110 preferably includes an array antenna where the control unit 130 adjusts an array according to a predetermined gain value. In the case of the array antenna, the signal from the high-orbit satellite 300 may be concentrated through the antenna unit 110 by beamforming. Thereafter, the control unit 130 may convert the GNSS signal received from the antenna unit 110 and transmit the GNSS signal to the receiving unit 200 of the ground. When a signal is received from the high-orbit satellite 300 other than the designated satellite, it is preferable to discard the signal. In this case, the signal reception details are stored and then transmitted to the server 400, so the server 400 may be used to double check the positional information of the high-orbit satellite 300.

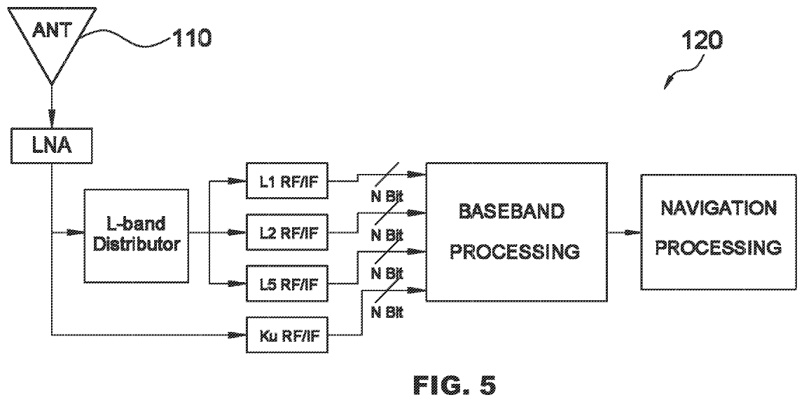

Hereinafter, the transmitting unit 120 of the present disclosure will be described in more detail with reference to FIG. 5.

As illustrated in FIG. 5, the transmitting unit 120 of the present disclosure may include a low noise amplifier (LNA) that amplifies the signal received from the antenna unit 110. In addition, the transmitting unit 120 may include a converter that converts the frequency of the amplified signal to an L band frequency band (1 to 2 GHz). The signal converted into the L band frequency band may be transmitted to a baseband processor through an L band RF/IF communicator, and thus, may be searched. In addition, the unconverted signal is transmitted to the baseband processor through a Ku band RF/IF communicator, so that code information of the signal may be tracked. Thereafter, the data is transmitted to the navigation processor, so the navigation information and the positional information may be interpreted. After going through this procedure, the transmitting unit 120 may transmit the signal to the receiving unit 200 of the ground. In this case, the delay time may be obtained through experiment.

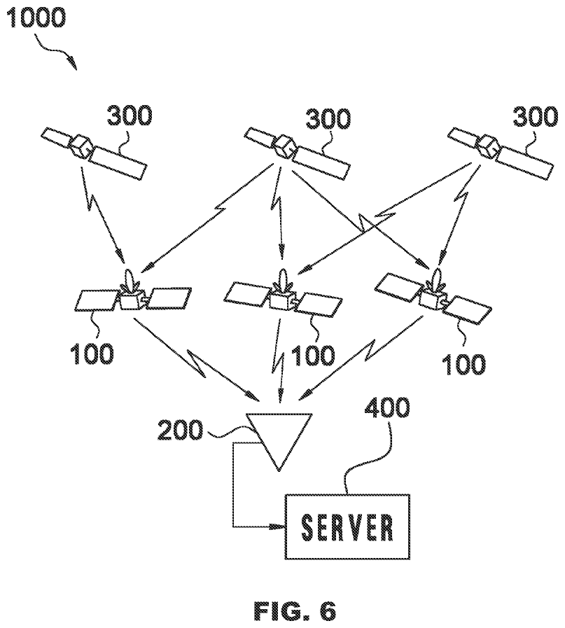

Hereinafter, a basic configuration of a satellite system 1000 of the present disclosure will be described with reference to FIG. 6.

As illustrated in FIG. 6, the satellite system 1000 of the present disclosure is a signal relay system that relays signals, including the low-orbit satellite 100, and may include the plurality of low-orbit satellites 100, the receiving unit 200 that receives the signal from the low-bit satellite 100, the plurality of high-orbit satellites 300 that transmit the signal to the antenna unit 110 of the low-orbit satellite 100, and the server 400 that receives the signal information from the receiving unit 200 to calculate and store the positional information of the receiving unit 200.

The server 400 may store the orbit information and the velocity information of the high-orbit satellite 300 and the orbit information and the velocity information of the low-orbit satellite 100. In addition, in order to calculate the pseudo-range and position, which will be explained later, a signal transmission delay time between the high-orbit satellite 300 and the low-orbit satellite 100, and a signal transmission delay time between the low-orbit satellite 100 and the receiving unit 200 may be stored.

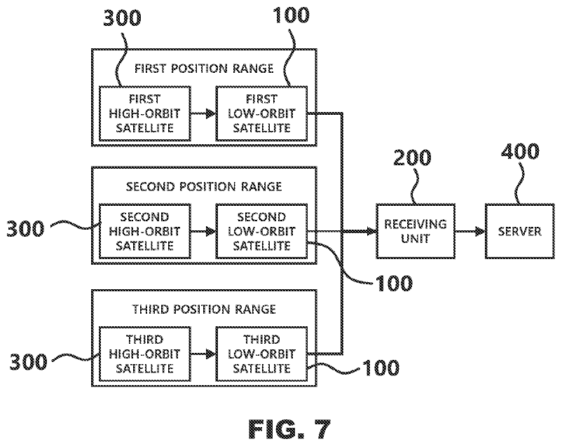

Hereinafter, the functions and algorithms of the server 400 of the present disclosure will be described in more detail with reference to FIG. 7.

As illustrated in FIG. 7, the server 400 preferably designates at least one of the high-orbit satellites 300 positioned within a predetermined distance range in a traveling direction of each low-orbit satellite 100 as the designated satellite of the low-orbit satellite 100 based on the orbit information and the signal reception range of the low-orbit satellite 100 and the orbit information and the signal transmission range of the high-orbit satellite 300.

In more detail, when the first low-orbit satellite 100, which is one of the low-orbit satellites 100, and the first high-orbit satellite 300 are both present within a first position range, the antenna unit 110 may be controlled by transmitting a signal to the control unit 130 of the first low-orbit satellite 100 so that it can easily receive the signal from the first high-orbit satellite 300. The same process may be performed even in the case of the second position range and the third position range.

Each position range may be designated based on the position of the high-orbit satellite 300, and is preferably set to correspond to the signal reception range of the high-orbit satellite 300. In this case, when the low-orbit satellite 100 does not exist in the position range, the communication may be made with the low-orbit satellite 100 that is closest to the high-orbit satellite 300 among the other position ranges. In this way, all the GNSS signals from the high-orbit satellite 300 may be relayed by the low-orbit satellite 100.

It is preferable that the server 400 stores a first delay time, which is the signal transmission time between the high-orbit satellite 300 and the low-orbit satellite 100, and a second delay time, which is the signal transmission time between the low-orbit satellite 100 and the receiving unit 200, and corrects the first delay time and the second delay time with the pseudo-range to determine the position of the receiving unit 200. In more detail, the travel time and the pseudo-range of the entire signal are calculated based on navigation information and a signal generation time of the received signal, the information (source information) of the high-orbit satellite 300 that generates the signal, and the like. Thereafter, the position of the receiving unit 200 may be determined by substituting the previously stored positional information, the first delay time, and the second delay time of the high-orbit satellite 300 into Equation.

In addition, the server 400 may designate a predetermined determination time and derive a position result value of the receiving unit 200 from all the signals received within the determination time. Thereafter, it is preferable to determine an average value of the position result values of the receiving unit 200 as a final position of the receiving unit 200. In this case, it is preferable that the determination time is longer than a multiple position error cycle of the low-orbit satellite 100.

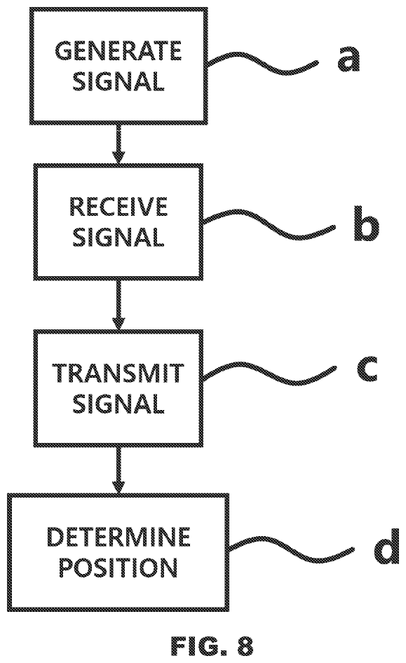

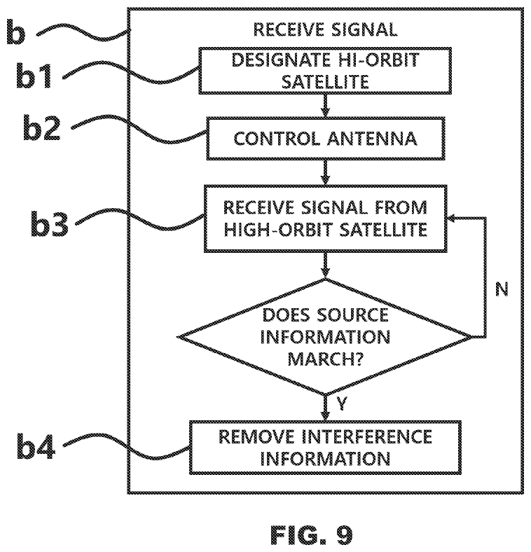

Hereinafter, a control method of a satellite system of the present disclosure will be described with reference to FIGS. 8 and 9.

As illustrated in FIG. 8, according to the present disclosure, the control method of a satellite system including a low-orbit satellite 100 to relay a signal preferably includes (a) generating, by the high-orbit satellite 300, a signal; (b) receiving, by the low-orbit satellite 100, the signal from the high-orbit satellite 300, (c) transmitting, by the low-orbit satellite 100, the signal to the receiving unit 200, and (d) determining, by the server 400, the position of the receiving unit 200.

In addition, as illustrated in FIG. 9, in step (b), the server 400 may include (b1) searching for high-orbit satellite 300 adjacent to each low-orbit satellite 100 and designating the high-orbit satellite as the designated satellite. The low-orbit satellite 100 may move at a faster speed at a lower altitude than the high-orbit satellite 300, so the corresponding neighboring high-orbit satellite 300 may vary according to the movement of the low-orbit satellite 100. Accordingly, the server 400 may match the low-orbit satellite 100 and its neighboring high-orbit satellites 300 based on the orbit and velocity information of the low-orbit satellite 100 and the high-orbit satellite 300.

In more detail, when the first low-orbit satellite 100, which is one of the low-orbit satellites 100, and the first high-orbit satellite 300 are both present within a first position range, the antenna unit 110 may be controlled by transmitting a signal to the control unit 130 of the first low-orbit satellite 100 so that it can easily receive the signal from the first high-orbit satellite 300. The same process may be performed even in the case of the second position range and the third position range.

Each position range may be designated based on the position of the high-orbit satellite 300, and is preferably set to correspond to the signal reception range of the high-orbit satellite 300. In this case, when the low-orbit satellite 100 does not exist in the position range, the communication may be made with the low-orbit satellite 100 that is closest to the high-orbit satellite 300 among the other position ranges. In this way, all the GNSS signals from the high-orbit satellite 300 may be relayed by the low-orbit satellite 100.

Thereafter, the control unit 130 may perform (b2) controlling the signal reception direction of the antenna unit 110 by communicating with the control unit 130 of the low-orbit satellite 100. In more detail, the control unit 130 may control the signal reception direction of the antenna unit 110 so that the reception range of the antenna unit 110 overlaps the signal transmission range of the designated satellite. In step (b1), after one of the high-orbit satellites 300 is designated as the designated satellite according to the position of the low-orbit satellite 100, the control unit 130 may control the signal reception direction of the antenna unit 110 to be toward the designated satellite based on a phase difference between the designated satellite and the low-orbit satellite 100 so that the signal from the designated satellite may be received more accurately. Thereafter, the low-orbit satellite 100 may receive a GNSS signal of the high-orbit signal, and convert the signal into a frequency that the above-described receiving unit 200 may receive and relay the signal.

Thereafter, the control unit 130 may include (b3) receiving, by the antenna unit 110, the signal from the high-orbit satellite 300. The control unit 310 may receive the signal and the source information of the signal from the antenna unit 110, and include determining that the source information of the signal is external interference information when the source information of the signal does not match the source information of the designated satellite, and (b4) discarding the interference information. Accordingly, when the low-orbit satellite 100 enters the signal transmission range of the plurality of high-orbit satellites 300, the low-orbit satellite 100 may transmit the signal from the high-orbit satellite 300 other than the designated satellite to prevent the information from interfering.

In step (d) described above, the server 400 may determine the position of the receiving unit 200. In more detail, it is preferable that the server 400 stores a first delay time, which is the signal transmission time between the high-orbit satellite 300 and the low-orbit satellite 100, and a second delay time, which is the signal transmission time between the low-orbit satellite 100 and the receiving unit 200, and corrects the first delay time and the second delay time with the pseudo-range to determine the position of the receiving unit 200. The server 400 may calculate the travel time and the pseudo-range of the entire signal based on the navigation information and the signal generation time of the received signal, the information (source information) of the high-orbit satellite 300 that generates the signal, and the like. Thereafter, the server 400 may determine the position of the receiving unit 200 by substituting the previously stored positional information, the first delay time, and the second delay time of the high-orbit satellite 300 into Equation.

In addition, the server 400 may designate a predetermined determination time and derive a position result value of the receiving unit 200 from all the signals received within the determination time. Thereafter, it is preferable to determine an average value of the position result values of the receiving unit 200 as a final position of the receiving unit 200. In this case, it is preferable that the determination time is longer than a multiple position error cycle of the low-orbit satellite 100.

As set forth above, according to a low-orbit satellite, a satellite system including the same, and a control method thereof according to the present disclosure configured as described above, a low-orbit satellite with high positioning accuracy is applied, but in order to reduce costs, the low-orbit satellite relays a signal from the existing high-orbit satellite and transmits the relayed signal to a signal receiving unit, thereby positioning of the receiving unit with high accuracy at low cost.

The present disclosure should not be construed to being limited to the above-mentioned exemplary embodiment. The present disclosure may be applied to various fields and may be variously modified by those skilled in the art without departing from the scope of the present disclosure claimed in the claims. Therefore, it is obvious to those skilled in the art that these alterations and modifications fall in the scope of the present disclosure.

What is claimed is:

1. A low-orbit satellite relaying signals from a plurality of high-orbit satellites to a ground receiving unit, the low-orbit satellite comprising:
an antenna unit configured to receive a signal the high-orbit satellite;
a transmitting unit configured to receive a signal from the antenna unit and transmit the signal to the receiving unit; and
a control unit configured to control the antenna unit,
wherein the control unit designates at least one of the high-orbit satellites as a designated satellite and controls the antenna unit to receive signals from the designated satellite.

2. The low-orbit satellite of claim 1, wherein the antenna unit includes a plurality of fixed antennas spaced apart from each other by a predetermined angle.

3. The low-orbit satellite of claim 1, wherein the antenna unit includes at least one of a helical antenna or a parabolic antenna whose angle is changed by the control unit.

4. The low-orbit satellite of claim 1, wherein the antenna unit includes an array antenna where the control unit adjusts an array according to a predetermined gain value.

5. The low-orbit satellite of claim 1, wherein the control unit controls a signal reception direction of the antenna unit so that a reception range of the antenna unit overlaps a signal transmission range of the designated satellite.

6. The low-orbit satellite of claim 1, wherein the control unit receives a signal and source information of the signal from the antenna unit, and
determines that the source information of the signal is external interference information when the source information of the signal does not match source information of the designated satellite, and discards signal data.

7. A satellite system which is a signal relay system of relaying a signal including a low-orbit satellite, the satellite system comprising:
a plurality of low-orbit satellites including the characteristics of claim 1;
a receiving unit configured to receive a signal from the low-orbit satellite;
a plurality of high-orbit satellites configured to transmit a signal to the antenna unit of the low-orbit satellite; and
a server configured to receive signal information from the receiving unit and calculate and store positional information of the receiving unit.

8. The satellite system of claim 7, wherein the server designates at least one of the high-orbit satellites positioned within a predetermined distance range in a traveling direction of each low-orbit satellite as the designated satellite of the low-orbit satellite based on orbit information and a signal reception range of the low-orbit satellite and orbit information and a signal transmission range of the high-orbit satellite.

9. The satellite system of claim 7, wherein the server derives a travel time of a signal and a pseudo-orange from the received signal, and
stores a first delay time, which is a signal transmission time between the high-orbit satellite and the low-orbit satellite, and a second delay time, which is a signal transmission time between the low-orbit satellite and the receiving unit, and corrects the first delay time and the second delay time with the derived pseudo-range to determine a position of the receiving unit.

10. The satellite system of claim 9, wherein the server designates a predetermined determination time and derives position result values of the receiving unit from each signal received within the determination time, and
determines an average value of the position result values of the receiving unit as a final position of the receiving unit.

11. A control method of a satellite system including a low-orbit satellite to relay a signal, the method comprising:
(a) generating, by a high-orbit satellite, a signal;
(b) receiving, by the low-orbit satellite, the signal from the high-orbit satellite;
(c) transmitting, by the low-orbit satellite, the signal to a receiving unit; and
(d) determining, by the server, a position of the receiving unit.

12. The control method of claim 11, wherein the step (b) includes, by the server,
(b1) searching for the high-orbit satellite adjacent to each low-orbit satellite and designating the searched high-orbit satellite as a designated satellite,
(b2) communicating with a control unit of the low-orbit satellite to control a signal reception direction of an antenna unit, and
(b3) receiving, by the antenna unit, the signal from the high-orbit satellite.

13. The control method of claim 12, wherein the step (b) further includes, by the control unit, (b4) following the step (b3) and discarding interference information when source information of the signal received from the antenna unit does not match source information of the designated satellite.
